(19) United States
(12) Patent Application Publication
(10) Pub. No.: US 2004/0117055 A1
(43) Pub. Date: Jun. 17, 2004

(54) Configuration and method for detecting defects on a substrate in a processing tool

(76) Inventors: Torsten Seidel, Ohorn (DE); Ralf Otto, Kesselsdorf (DE); Karl Schumacher, Dresden (DE); Thorsten Schedel, Dresden (DE); Eckhard Marx, Radeburg (DE); Gunter Hraschan, Dresden (DE)

Correspondence Address: LERNER AND GREENBERG, PA, P O BOX 2480, HOLLYWOOD, FL, 33022-2480, US

(21) Appl. No.: 10/715,073

(22) Filed: Nov. 17, 2003

Related U.S. Application Data
(63) Continuation of application No. PCT/EP02/05189, filed on May 10, 2002.

(30) Foreign Application Priority Data
May 17, 2001 (EP) 01112140.7

(51) Int. Cl. G06F 19/00

(52) U.S. Cl. 700/121; 700/110

(57) ABSTRACT

A processing tool for manufacturing semiconductor devices, e.g. a lithography cluster, has a device transfer area with an optical sensor (e.g. CCD-camera), and an illumination system. A substrate (e.g., a semiconductor wafer, a reticle, or a mask for exposure on the wafer) that is transferred to or from one of its processing chambers can be scanned during its movement at low resolution. Scanning is performed before and after processing in at least one the processing chambers of the processing tool. The images are compared and optionally subtracted from each other. Defects imposed to the substrate due to contaminating particles only during the present processes with sizes larger than 10 μm are visible on the subtracted image. Defects imposed earlier are diminished as well as structures formed from a mask pattern below 10 μm. Pattern recognition allows efficient classification of the defects just detected in a processing tool. Semiconductor device yield and metrology capacity are advantageously increased.

### CROSS-REFERENCE TO RELATED APPLICATION

This application is a continuation of copending International Application No. PCT/EP02/05189, filed May 10, 2002, which designated the United States and which was published in English.

### BACKGROUND OF THE INVENTION

### FIELD OF THE INVENTION

The present invention relates to a method and a device for detecting defects on a substrate in a processing tool, a device transfer area, an optical sensor and an illumination system for illuminating an area monitored by the optical sensor.

In semiconductor manufacturing—particularly semiconductor wafers, masks or reticles—a sequence of processing steps is performed to build structures such as integrated circuits on their surfaces. Many of these processing steps are followed by metrology steps in order to check whether the process just carried out fulfills the corresponding device specification requirements.

In the case of semiconductor wafers, e.g., four measurement operations are often needed to monitor the quality of the lithographic process including the full cleantrack, i.e. coating and developing etcetera. These operations typically include an overlay measurement, a critical dimension measurement, a flood light inspection, and an additional microscope inspection. Semiconductor devices failing these examinations are commonly sent into rework.

Although for such device quality checks high resolution is often not necessary in order to detect defects such as focus spots etc., that have just been imposed to the devices, elaborate metrology tools available in the fab inevitably have to be used to carry out the required inspections or measurements. Thus, in many instances expensive metrology tools are used to process simple checks.

Moreover, since large distances in the cleanroom area have to be traveled for transferring a semiconductor device from a process tool to a metrology tool, time is lost, and the information feedback for solving problems with the processing tool is disadvantageously slow.

In the case of reticles or masks to be used to expose a semiconductor wafer with a pattern within an exposure tool, it can also occur that defects deposited on the reticles surface are imaged onto the wafer surface, thus decreasing the wafer yield. Specific reticle inspection tools are therefore used to perform the necessary checks of detecting and classifying defects or particles on its front or backside surface. This disadvantageously leads to further consumption of tool time and also additional equipment is required.

### SUMMARY OF THE INVENTION

It is accordingly an object of the invention to provide a method and a device for detecting defects on a substrate in a processing tool which overcomes the above-mentioned disadvantages of the heretofore-known devices and methods of this general type and which reduces the efforts spent in measurement operations before, during or after a process for manufacturing semiconductor devices, thereby decreasing the costs spent in metrology tools, and to reduce the amount of rework of semiconductor devices thereby optimizing the processing tool utilization time.

With the foregoing and other objects in view there is provided, in accordance with the invention, a configuration for detecting defects on a substrate within a processing tool, comprising:

a loadport for loading or unloading the substrate to the processing tool;

a device transfer area within the processing tool;

a robot handling area connected to the load port and communicating with the device transfer area through an input slot;

at least one processing chamber formed in the processing tool;

a robot arm configured to transfer substrates between the load port, the robot handling area, and the at least one processing chamber;

an optical sensor with an illumination system mounted within the device transfer area above the input slot, for recording an image of a respective substrate being held by the robot arm in the device transfer area; and

a control unit connected to the optical sensor for recording the image taken with the optical sensor, and for comparing images taken by the optical sensor.

According to the present invention an in-situ measurement of substrates such as reticles, masks, flat panels, or semiconductor wafers in a processing tool is provided. A prerequisite of the present invention is that the process tool is part of a configuration including a load port, a device transfer area typically being operated by a robot having an arm for transporting the devices, and an active processing unit, i.e. a processing tool.

The method and configuration according to the present invention are aiming at monitoring and controlling low resolution device structures, which therefore do not require a long measurement time, a high precision alignment, or a high resolution sensor. This is performed by means of an optical sensor, which can be a CCD-camera being able to record pictures of the devices with a resolution of a few to hundreds of microns.

In this document the area of the processing tool inside a load port and outside the processing chamber, i.e. the active processing unit of a processing tool, is considered to be the device transfer area.

The optical sensor and the illumination system are integrated within the process tool periphery, i.e. the device transfer area. Thus, the present invention is suited to cleanroom area processing tools having a loadport, where device carriers are laid upon in order to be unloaded from their device load by means of robot arms. Those processing tools commonly provide a mini-environment within, and all device handling is arranged such as to minimize contamination with particles due to, e.g., mechanical friction and abrasion.

Device handling and transfer is often provided by robots or similar mechanics comprising robot arms having chuck-like properties to hold a substrate such as a semiconductor device, e.g. a semiconductor wafer, or a mask/reticle.

The present invention utilizes two characteristics of the device transfer area: Typically, semiconductor devices or reticles are transferred to the processing chambers and removed from the processing chambers along similar paths. Additionally, transfer velocities are sufficiently slow, such that low resolution images can be taken from the semiconductor devices while being transferred.

A further advantage is, that a common device transfer area of semiconductor manufacturing equipment has comparatively large amounts of space left to receive typical optical sensors.

The central issue of the present invention is, that a low resolution picture of the substrate is taken before and after one or more process steps. Both pictures are then compared, the differences thereby showing large scale effects that have been applied to the semiconductor device or the reticle, respectively.

A main contributor to defects detected conventionally using metrology tools are focus spots on semiconductor device. These are originating from particles adhering to the backside of the semiconductor device, particularly semiconductor wafers. A small elevation of the device frontside develops, which in the case of exposing a semiconductor wafer results in a defocus with respect to the optical system of the exposure tool. Although the elevation is small—having roughly the size of the particle diameter—the lateral extent can become up to 1×1 cm or even larger. Inside such an area pattern structures hardly develop in the resist. As a result the corresponding integrated circuit is damaged. Those large scale defects can easily be seen by eye e.g. by means of a floodlight inspection.

Using the optical sensor and the method according to the present invention the subtracted images in low resolution reveal nearly constant differences between the pre-process and the post-process device image with the exception of large scale defect contributions due to contaminating particles such as focus spots on semiconductor wafers imposed during the present process. Contrarily, large scale features that have been structured on the device surface before are evident on both pictures before subtraction—pre-process and post-process—and are therefore not evident on the subtracted image. Thus, the present invention advantageously allows a defect control of precisely the present process or sequence of process steps.

Commonly, structures imprinted onto the semiconductor device due to the present process, e.g. exposure with a mask pattern, generally have a smaller structure size, and are therefore not resolved with the optical sensor according to the present invention. Thus, the structures will not be detected as differences in the compared or subtracted images.

Most preferably, optical sensors having a resolution of 50-100 μm are used according to the present invention, but also more expensive cameras with resolutions down to 10-20 μm can be applied according to the actual state camera technology.

According to the method of the present invention a signal is generated in response to the comparison of the first and second image. Preferably, the signal is issued in response to a defect pattern recognized in a subtracted image. In an aspect of the present invention further processing of semiconductor devices is considered to be stopped, if a threshold value of e.g. defect numbers or size is exceeded. Also, the signal may comprise information for the work-in-progress system about the semiconductor device identification number affected and/or the location of the defect on said device.

In a further aspect the method is considered to comprise a pattern recognition property, which identifies patterns in the subtracted image after which it compares the identified pattern with at least one reference pattern, preferably with a library of reference patterns. In a further aspect each of the reference patterns from the library is considered to represent different kinds of defects. According to still a further aspect examples of patterns are a particle on a device backside causing a focus spot as described above, a particle on a device frontside causing distortions during the resist spin on (comets), and particles on a device frontside causing resist lift-off when being buried below the resist.

Another advantageous aspect of the present invention is the property of recording the images using the optical sensor during the semiconductor device or reticle movement while it is transferred, the sensor being constructed as a scanning system. Thereby, the optical sensor may be mounted above the substrate transfer path and the movement for performing the scanning is provided by the robot arm transfer. An on-the-fly inspection of 5 seconds is possible, then. A corresponding backside inspection of the reticle can be enabled by an optical sensor mounted below the device transfer path. A simultaneous inspection is either possible by providing two sensors according to the present invention—one mounted above and the other mounted below said transfer path—or by supplying a moving means or a mirror to the configuration.

A mechanical movement of optical parts of the optical sensor provides a corresponding depth of focus, which is necessary, if the vertical transfer path height to and from the processing chamber deviate from each other. In the case of a lithography cluster having an in- and output slot for providing semiconductor wafers from a robot area to the device transfer area these deviations typically amount to, for example, 4 cm, with which the corresponding vertical movement of the optical sensor is at least to be provided.

According to the present invention the device transfer area may also serve for transferring semiconductor devices between a sequence of processing tools. In the case of the lithography cluster coating, exposure and developing are performed sequentially and the images are taken before the coating step and after the developing step.

According to the present invention a method of detecting defects on a robot arm without carrying a substrate is also provided. Comparing the pictures of the robot arm before carrying out one or more transfer actions and after it, newly adhering particles stuck to the robot arm surface can easily be detected.

The present invention also refers to detecting defects or particles residing on the front or backside surfaces of reticles, that are used to expose a semiconductor wafer with a pattern. In this document the term reticle refers to reticles as well as masks. The reticles are selected and loaded to the loadport from a reticle library. They are transferred to the device transfer area by means of a reticle handler, which is a robot arm having an appropriate platform for holding the reticle. During this transfer an image is taken by means of the configuration of the present invention. The image is then compared with a reference image, e.g., of a classified defect.

According to the present invention using the optical sensor and the pattern recognition software a large scale device identification number printed on the device surface can also be detected.

Other features which are considered as characteristic for the invention are set forth in the appended claims.

Although the invention is illustrated and described herein as embodied in an configuration and method for detecting defects on a substrate in a processing tool, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a front view of a configuration according to the present invention in a lithography cluster;

FIG. 1B is a side view of the configuration;

FIG. 2 is a schematic perspective illustration of an optical sensor for detecting defects on a semiconductor wafer according to an embodiment of the present invention;

FIG. 3 is a flow chart of a lithography process of semiconductor wafers with an in-situ defect control according to the method of the present invention; and

FIG. 4 is a schematic perspective view of two optical sensors for detecting defects on a reticle front and backside (pellicle) according to an embodiment of the present invention.

### DESCRIPTION OF THE PREFERRED EMBODIMENTS

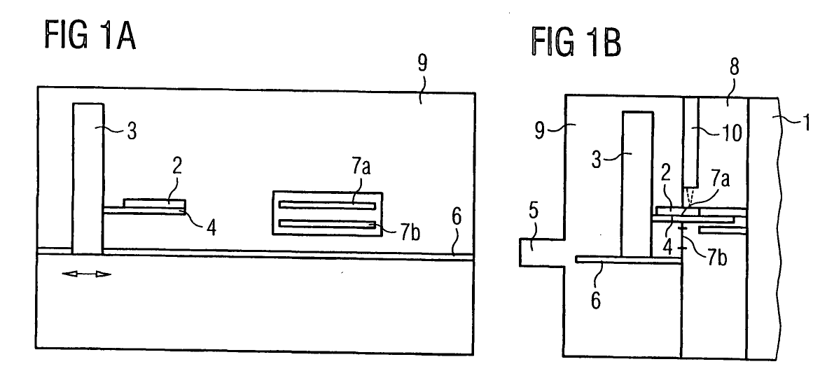

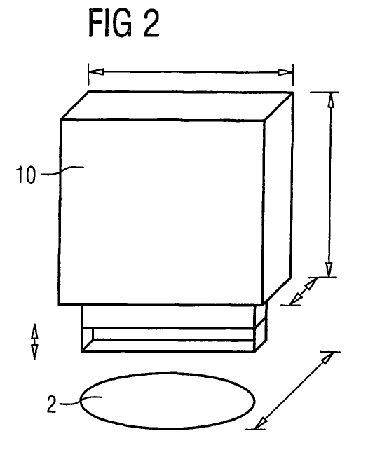

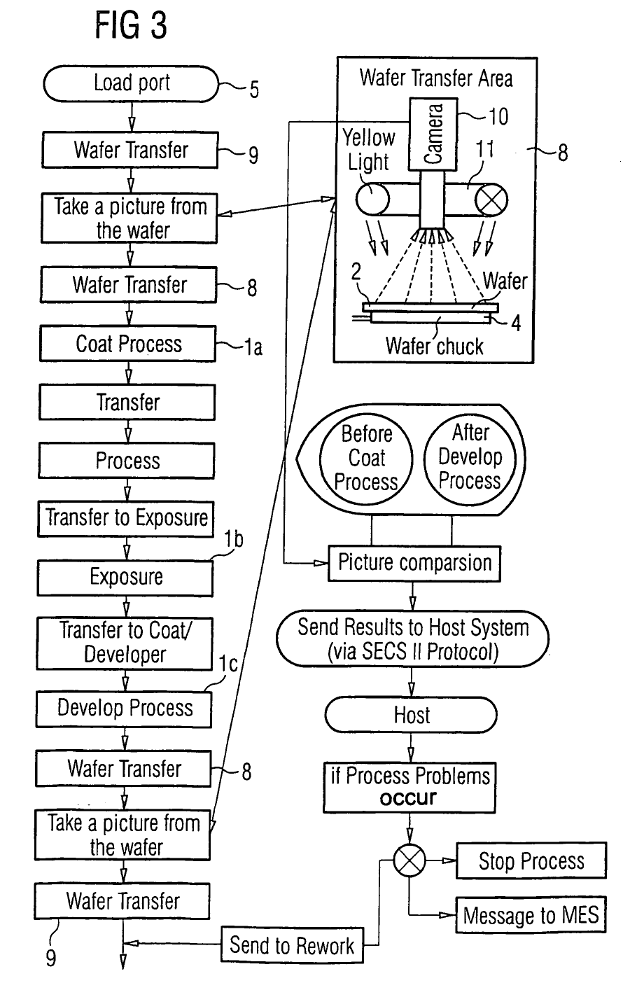

Referring now to the figures of the drawing in detail and first, particularly, to FIGS. 1A and 1B thereof, there is shown a lithography cluster representing an embodiment of the present invention. In the front view of the cluster in FIG. 1A, a robot 3 carrying a semiconductor wafer 2 on its robot arm 4 is shown to move along a linear axis 6 for robot movement. The robot 3 transfers the semiconductor wafer 2 from a load port 5 to an input slot 7a. The input slot 7a is the input connection between the robot handling area 9 and the device transfer area 8. As shown in FIG. 1B the robot 3 transfers the semiconductor device 2 through the input slot 7a into the device transfer area 8 for being further transported to the coating processing tool (step 1a in FIG. 3).

An optical sensor 10 is mounted above the input slot 7a, such that the semiconductor wafer 2 is scanned while being transferred through input slot 7a. The duration of the scan is about 5 seconds. The optical system of the optical sensor 10 is provided with a motor such as to provide a focus depth of 4 cm, which is the difference in height between the input slot 7a and the output slot 7b, through which the semiconductor wafers are transferred after processing through the coat process 1a the exposure 1b and the develop process 1c among further steps.

In order to scan, for example, 300 mm wafers the optical sensor has a width of 32 cm—the same as the input and output slot width—with a height of 36 cm and a depth of 6 cm. A control unit provides a synchronization between the wafer transfer and the inspection during the scan. A one-dimensional image is taken while the orthogonal movement provides the scan in the second dimension.

The method according to the present invention is illustrated in the flow chart of FIG. 3. A semiconductor wafer is unloaded from a device carrier deposited on a load port 5 of a lithography cluster. By means of the robot 3 the semiconductor device is transferred through the robot handling area 9 and scanned for recording an image by the optical sensor 10 when being transferred through the input slot 7a. After that the automatic handling system transfers the semiconductor wafer 2 through the device transfer area 8 to a coater 1a. After being further transferred and processed the wafer is exposed with a mask pattern in an exposure tool 1b and than transferred to the developer 1c.

Eventually, the semiconductor wafer 2 is transferred back to the output slot 7b. While sliding through the slot, the second image is taken with a CCD-camera 10 as an optical sensor. During recording the images the semiconductor wafer 2 is illuminated annularly in yellow light by an illumination system 11. Both pictures—before the coat process and after the develop process—are then compared and the results sent, e.g., via a SECS II connection to the lithography cluster host system. There, the pattern recognition is performed and particle defects are detected. These are classified, and if a threshold value of particle sizes or numbers is exceeded, a signal directed to the host is issued for stopping the current process and marking the current product to be sent into rework.

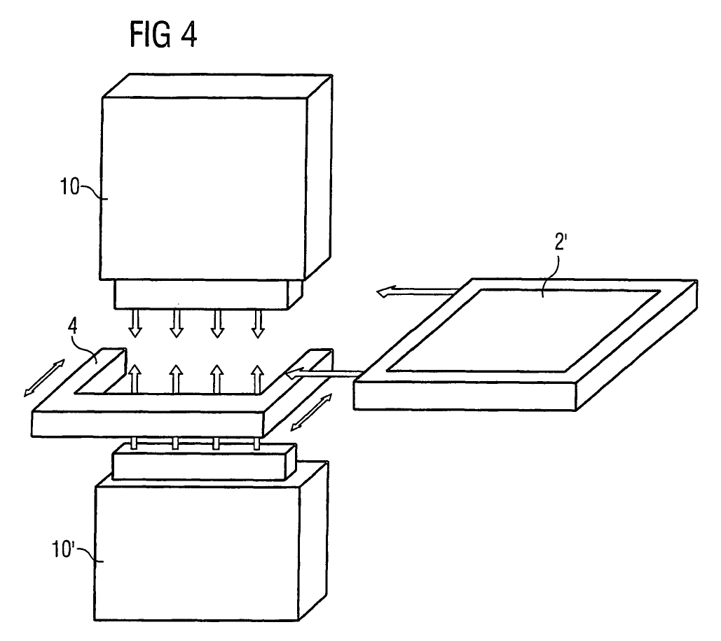

FIG. 4 displays an embodiment of optical sensors 10, 10′, which are part of an configuration used to scan a reticle on its transfer path from a reticle library to an image position in front of a projection lens in a processing chamber of an exposure tool. The optical sensors 10, 10′ are arranged to image a plane, in which a reticle handler robot arm 4 transfers the reticle 2′. The movement of the reticle 2′ preferably is carried out within the plane that is currently formed by the reticle. The scanning is then enabled by a slow movement of the reticle handler robot arm through the space between both optical sensors 10, 10′ as shown in FIG. 4.

The reticle handler robot arm 4 has the form of a fork such as to contact the reticle 2′ just at an outer frame. The reticle pattern therefore may be viewed from a top position by means of optical sensor 10 to examine its front side and from a bottom position by means of optical sensor 10′ to examine its backside. A pellicle is, e.g., mounted on the reticle backside, and optical sensor 10′ can be focused or positioned to detect particles adhering to the pellicle.

The transfer path according to this embodiment is positioned in the device transfer area of the exposure tool. Thus, the reticle needs not to be removed from the combined mini-environment of the reticle library and the exposure tool in order to be checked for particles in a separate reticle inspection tool or pellicle checker. Since the quality of the reticle pattern is retained, the yield of semiconductor devices to be exposed with the reticle pattern is improved as compared to prior art.

As described in the foregoing the reticle handler robot arm itself can be inspected for particles, if no reticle is currently carried with it.

Advantageously, using this embodiment macro defect control of reticles inclusive classification down to at least 30 microns becomes possible if a CCD-camera is used.

In a further embodiment, the positions of alignment marks being structured on the reticles are detected using the optical sensor 10, such that a global alignment procedure, i.e., a coarse alignment, prior to a fine adjustment can be facilitated.

In still a further embodiment referring to FIG. 4 a barcode patterned on the reticle can be read out using the optical sensors 10 or 10′ in order to issue a signal, if the corresponding identification does not meet with requirements provided by the manufacturing scheduling of the fab-wide CIM-system.

The optical sensors are equipped with focusing means in order to retrieve a sharp image at a desired location in the transfer path. Either, a motor shifts the complete optical sensor perpendicularly to or from the plane to be scanned during a movement of a device, or the sensor comprises a set of lenses, which can be dislocated with respect to each other such as to alter the focus.

In a further embodiment the images taken from the reticles or masks during the scanning movement are stored in a database. The optical sensors, or the control unit as a digital image processing unit, comprise a zoom function to take an image at just the location of interest on the reticle, e.g. the defect area. This embodiment is also applicable to the case of the foregoing embodiments referring to semiconductor devices.

Alternatively, the images can be displayed at a display device, which is connected to the digital image processing unit, i.e. the control unit. Advantageously, in case an operator can classify a defect already at the moderate resolution of the optical sensors 10, he might recognize, that the defect is tolerable, thus rendering a detailed inspection in a separate tool unnecessary.

In still a further embodiment the configuration comprises a cleaning means, which is mounted within the device transfer area 8 along the transfer path, and which effects, e.g., an air flow or ultrasonic waves to remove particles in response to the signal issued in case of detecting a contaminating particle using the configuration.

We claim:

1. A configuration for detecting defects on a substrate within a processing tool, comprising:
a loadport for loading or unloading the substrate to the processing tool;
a device transfer area within the processing tool;
a robot handling area connected to said load port and communicating with said device transfer area through an input slot;
at least one processing chamber formed in the processing tool;
a robot arm configured to transfer substrates between the load port, said robot handling area, and said at least one processing chamber;
an optical sensor with an illumination system mounted within said device transfer area above said input slot, for recording an image of a respective substrate being held by said robot arm in said device transfer area; and
a control unit connected to said optical sensor for recording the image taken with said optical sensor, and for comparing images taken by said optical sensor.

2. The configuration according to claim 1, wherein said optical sensor is a sensor configured for performing a macro-defect inspection.

3. The configuration according to claim 1, wherein said optical sensor has a minimum resolvable structure width of more than 10 μm and of less than 100 μm.

4. The configuration according to claim 1, wherein:
said optical sensor is a scanner recording images in columns from said substrate during a movement of said substrate effected by said robot arm;
said control unit is connected to a motor moving said robot arm for obtaining the substrate position during the movement; and
said control unit includes a processing unit for building an image from the image columns and the substrate positions.

5. The configuration according to claim 1, wherein said optical sensor includes a focusing means connected to said control unit for focusing said optical sensor to a distance according to a height of a transfer path of said substrate.

6. The configuration according to claim 1, wherein:
the substrate is a reticle or a mask;
said loadport is connected to a reticle library;
said processing tool is an exposure tool; and
said optical sensor is a CCD-camera.

7. The configuration according to claim 1, wherein the substrate is a semiconductor wafer and said loadport is configured to receive a wafer carrier.

8. A method for detecting defects on a mask or reticle within an exposure tool having a reticle library, a device transfer area, an optical sensor, and an illumination system for illuminating an area monitored by the optical sensor, the method which comprises:
transferring a reticle from the reticle library to the device transfer area;
recording an image of the mask or reticle with the optical sensor to generate a recorded image;
comparing the recorded image with a reference image;
issuing a signal in response to the comparison; and
transferring the mask or reticle to the exposure tool and exposing a semiconductor wafer using the mask or reticle in response to the signal.

9. A method for detecting defects on a semiconductor device within a processing tool, the processing tool including a device transfer area, an optical sensor, and an illumination system for illuminating an area monitored by the optical sensor, the method which comprises:
providing the semiconductor device to the device transfer area;
recording a first image of the semiconductor device using the optical sensor;
transferring the semiconductor device to the processing tool;
performing a process step on the semiconductor device;
transferring the semiconductor device back to the device transfer area;
recording a second image of the semiconductor device using the optical sensor;
comparing the first image with the second image; and
issuing a signal in response to the comparison.

10. The method according to claim 9, wherein the comparing step comprises:
subtracting one of the images from the other one of the images to generate a subtracted image;
identifying a pattern in the subtracted image; and
comparing the pattern with at least one reference pattern.

11. The method according to claim 10, wherein the at least one reference pattern is a pattern representing a defect on a semiconductor device.

12. The method according to claim 9, wherein the defect is at least one of:
a particle on a device backside causing a focus spot;
a particle on a device frontside causing distortions during resist spin-on; and
a particle on a device frontside causing resist lift-off.

13. The method according to claim 9, which comprises recording the first and second images by scanning the semiconductor device during a movement of the semiconductor device across the device transfer area.

14. The method according to claim 9, which comprises stopping a processing of the inspected semiconductor device in response to the signal.

15. A method for detecting defects on a robot arm in a processing tool, the processing tool including a device transfer area, an optical sensor, and an illumination system, and the robot arm is configured to transfer a substrate to the device transfer area, and the method which comprises:
moving the robot arm to the device transfer area without being loaded with a substrate;
recording a first image of the robot arm in the device transfer area;
transferring a number of substrates to and from the device transfer area with the robot arm;
moving the robot arm to the device transfer area without being loaded with a substrate;
recording a second image of the robot arm in the device transfer area;
comparing the first image and the second image; and
issuing a signal in response to the comparison.

16. A method for detecting a substrate identification number patterned on a surface of a substrate in a processing tool, the processing tool including a device transfer area, an optical sensor, and an illumination system, and the method which comprises:
delivering the substrate to the device transfer area;
recording an image of the substrate;
identifying the identification number by way of a pattern recognition algorithm; and
issuing a signal in response to the identification.
